(19) United States
(12) Patent Application Publication
(10) Pub. No.: US 2002/0084120 A1
(43) Pub. Date: Jul. 4, 2002

(54) Motor assembly with independent motor units

(76) Inventor: Leslie R. Beasley, Flower Mound, TX (US)

Correspondence Address: LAW OFFICES OF GRADY K. BERGEN, 2626 COLE AVENUE, SUITE 400, DALLAS, TX, 75204, US

(21) Appl. No.: 09/753,364

(22) Filed: Jan. 2, 2001

(51) Int. Cl. B60K 1/00

(52) U.S. Cl. 180/65.3

(57) ABSTRACT

A motor assembly which utilizes a main power shaft that is powered by individual motor units is provided. The motor assembly can be provided with a number of motor units, each being operated by a different fuel source, such as gasoline, diesel or electrical power. This gives a great degree of flexibility in how the motor assembly is operated. The motor units are constructed to be interchangeable and easily removed and replaced. Different output shafts, that can be oriented at different orientations, can be joined and driven by the main power shaft. The motor assembly can also be used as a hybrid motor, running on both combustible fuel and electric power. This provides great fuel efficiency, while providing high power or torque when necessary.

### BACKGROUND

Conventional combustion engines usually employ a piston and cylinder engine powered by a combustible fuel mixture. The engine will typically have multiple pistons and cylinders mounted within a single engine block, with the pistons coupled by means of piston rods to the length of a single crankshaft. The engine will usually only operate on a single type of combustible fuel, such as gasoline, diesel fuel, natural gas, etc. The pistons and cylinders may be arranged in various configurations within the engine block, such as a “straight four,” “V-6” or “V-8” arrangement, commonly used in many automobile engines. In the case of a motorized vehicle or vessel, power is transmitted from the engine to the propulsion system of the vehicle or vessel, such as the wheels or axle of an automobile or the propeller of an airplane, boat or ship. While a large number of these engines are used in propulsion systems, these engines may also be used for other non-propulsion applications, such as for powering generators, pumps, compressors, etc.

Because most engines typically operate within optimal revolution or r.p.m. ranges, a transmission system having multiple gears may be provided to provide different gear ratios to thereby adjust the speed or power supplied to the system being powered by the engine.

While the engine may be used to power a primary system, such as a propulsion system of a vehicle, the engine may also be used to power auxiliary systems. These may include such things as the automobile engine's cooling system, air conditioning unit, electrical generator or alternator, etc. In automobile, where a majority of combustion engines are employed, for example, this is often accomplished through the use of fan belts which are coupled to the crankshaft of the engine.

Because conventional engines may utilize a single crankshaft to power virtually all, if not most, of the system and its various components, failure of any one of the engine's components, including the crankshaft, engine block, pistons, piston rods, etc., can result in a complete failure or shut down of the system with which the engine is being used. This can be a particular problem in applications where engine failure can have drastic results, such as in airplanes or military applications. Furthermore, repair or replacement of the engine may be difficult, requiring a complete or substantial disassembly of the engine to repair only minor elements or components.

It would therefore be advantageous to provide an engine or motor assembly that can be used in a variety of different applications, but which overcomes many of those limitations associated with prior art engines.

### SUMMARY

A motor assembly is provided having a motor assembly housing. The motor assembly housing has at least one motor unit receiver. A main power shaft assembly is housed within the motor assembly housing and has a main shaft with a longitudinal axis extending between opposite ends of the main shaft. At least one shaft element is coupled to the main shaft. The shaft element is rotatable about the longitudinal axis and engages the main shaft so that rotation of the shaft element about the longitudinal axis causes the main shaft to rotate about the longitudinal axis.

At least one motor unit is received by the motor unit receiver of the motor assembly housing. The motor unit has a motor and a drive shaft. The drive shaft is rotatably driven about a drive shaft axis of the drive shaft by the motor, and wherein the motor unit is releasably engagable with the main power shaft assembly when the motor unit is received within the motor unit receiver of the motor assembly housing so that rotation of the drive shaft causes rotation of the shaft element about the longitudinal axis of the main shaft to thereby rotate the main shaft when engaged. The motor unit is substantially self-contained to facilitate removal and replacement of the motor unit.

In another embodiment, a motor assembly is provided having a main power shaft assembly. The main power shaft assembly has a main shaft with a longitudinal axis extending between opposite ends of the main shaft. At least one shaft element is coupled to the main shaft. The shaft element is rotatable about the longitudinal axis and engages the main shaft so that rotation of the shaft element about the longitudinal axis causes the main shaft to rotate about the longitudinal axis.

At least two motor units are provided with the motor assembly. Each motor unit has a motor and a drive shaft. The drive shaft is rotatably driven about a drive shaft axis of the drive shaft by the motor. Each motor unit is releasably engagable with the main shaft so that rotation of the drive shaft of each motor unit causes rotation of the shaft element about the longitudinal axis of the main shaft to thereby rotate the main shaft when engaged. Each motor unit is capable of rotating the main shaft by rotation of the shaft element by the drive shaft when the other of said at least two motor units is disengaged from the main shaft. The at least two motor units are capable of rotating the main shaft in a cooperating relationship when both the at least two motor units are engaged with the main shaft.

In still another embodiment of the invention, a motor assembly is provided with a motor assembly housing having at least two motor unit receivers. A main power shaft assembly is housed within the motor assembly housing. The main power shaft assembly has a main shaft with a longitudinal axis extending between opposite ends of the main shaft. At least one shaft element is coupled to the main shaft. The shaft element is rotatable about the longitudinal axis and engages the main shaft so that rotation of the shaft element about the longitudinal axis causes the main shaft to rotate about the longitudinal axis.

At least two motor units are provided with the motor assembly. Each motor unit is independently operated and received by one of the motor unit receivers of the motor assembly housing. Each motor unit has a motor and a drive shaft. The drive shaft is rotatably driven about a drive shaft axis of the drive shaft by the motor. Each motor unit is releasably engagable with the main shaft so that rotation of the drive shaft of each motor unit causes rotation of the shaft element about the longitudinal axis of the main shaft to thereby rotate the main shaft when engaged. Each motor unit rotates the main shaft by rotation of the shaft element by the drive shaft when the other of said at least two motor units is disengaged from the main shaft, and wherein the at least two motor units each rotate the main shaft in a cooperating relationship when both the at least two motor units are engaged with the main shaft.

In specific embodiments of the invention, the motor units may utilize a different motor, such as a combustible fuel engine or an electric motor. Each motor unit may utilize a different combustible fuel. If an electric motor is used, the electric motor may operate in power mode, in which the motor drives the drive shaft of the motor unit, and in a generator mode in which in which the electric motor serves as an electric generator.

The motor unit drive shafts and one or more output shafts, also provided with the motor assembly and having a longitudinal output shaft axis and which is engaged with the shaft element of the main power shaft so that rotation of the main power shaft causes the output shaft to rotate about the output shaft axis, may be oriented at different angles with respect to the longitudinal axis of the main shaft. The motor assembly also allows the drive shafts from different motor units to rotate at different rates when rotating the main shaft.

The motor assemblies may be used in a vehicle or vessel.

### BRIEF DESCRIPTION OF THE DRAWINGS

For a more complete understanding of the present invention, and the advantages thereof, reference is now made to the following descriptions taken in conjunction with the accompanying figures, in which:

FIG. 1 is a top plan view of a motor assembly, shown without a motor assembly housing and showing the engagement of motor units with a main power shaft assembly of the motor assembly, and constructed in accordance with the invention;

FIG. 2 is an elevational view of various motor units and drive shafts engaged with the main power shaft assembly of the motor assembly of FIG. 1;

FIG. 3 is an elevational view of another embodiment of a main power shaft assembly showing a clutch plate mechanism and various drive shafts engaging the main power shaft assembly in different orientations, and constructed in accordance with the invention;

FIG. 4 is an elevational view of a main power shaft assembly and a drive shaft having straight-edged gears engaged with one another, and constructed in accordance with the invention;

FIG. 5 is a perspective view of motor unit module for use in the motor assembly of FIG. 1, and constructed in accordance with the invention;

FIG. 6 is a top plan view of the motor assembly of FIG. 1, showing a motor assembly housing of the motor assembly with receivers for receiving motor unit modules of the motor assembly, and constructed in accordance with the invention;

FIG. 7 is a cross-sectional side view of the motor unit module of FIG. 5;

FIG. 8 is a cross-sectional side view of the motor unit housing of FIG. 6, showing the engagement of motor unit modules with the main power shaft assembly of the motor assembly;

FIG. 9 is a cross-sectional side view of a portion of a block housing of the motor assembly of FIG. 1 engaged with a portion of a motor unit module, and showing conduits for fluid flow between the block housing and the motor unit;

FIG. 10 is a side elevational view of a cam shaft assembly for a motor unit of the motor assembly of FIG. 1, and constructed in accordance with the invention;

FIG. 11 is a cross-sectional view of the cam shaft assembly of FIG. 10 taken along the lines XI-XI;

FIG. 12 is a partial cross-sectional side view of a valve assembly of a motor unit, and constructed in accordance with the invention;

FIG. 13 is a schematic representation of a system employing a motor assembly in accordance with the invention;

FIG. 14 is a schematic representation of a vehicle employing a motor assembly in accordance with the invention;

FIG. 15 is a top plan view of another embodiment of a motor assembly, shown partially section, and constructed in accordance with the invention;

FIG. 16 a cross-sectional side view of a motor unit of the motor assembly of FIG. 15, constructed in accordance with the invention;

FIG. 17 is a rear elevational view of the motor unit of FIG. 16, showing a cam drive assembly of the motor unit, and constructed in accordance with the invention;

FIG. 18 is a cross-sectional view of the motor assembly of FIG. 15, taken along the lines XVIII-XVIII;

FIG. 19 is a perspective view of the motor assembly of FIG. 15, shown with some of the motor units removed; and

FIG. 20 is a diagram illustrating different applications for the motor assembly, in accordance with the invention.

### DETAILED DESCRIPTION

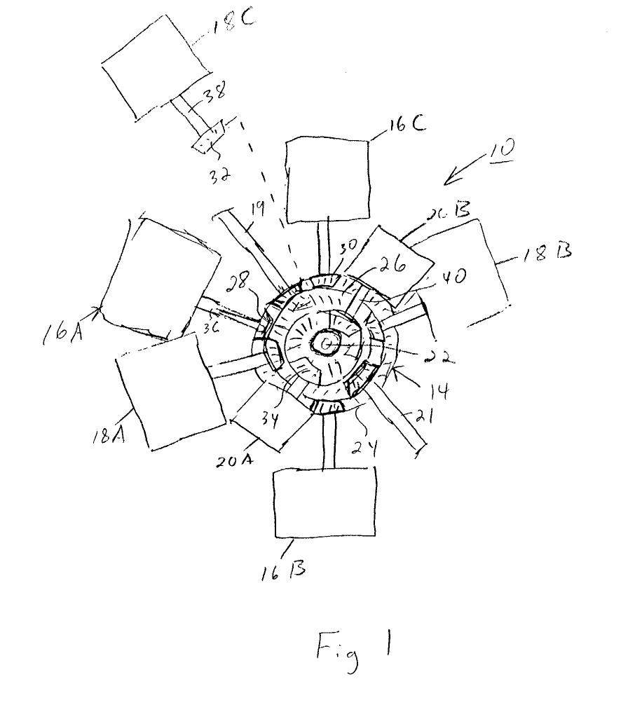

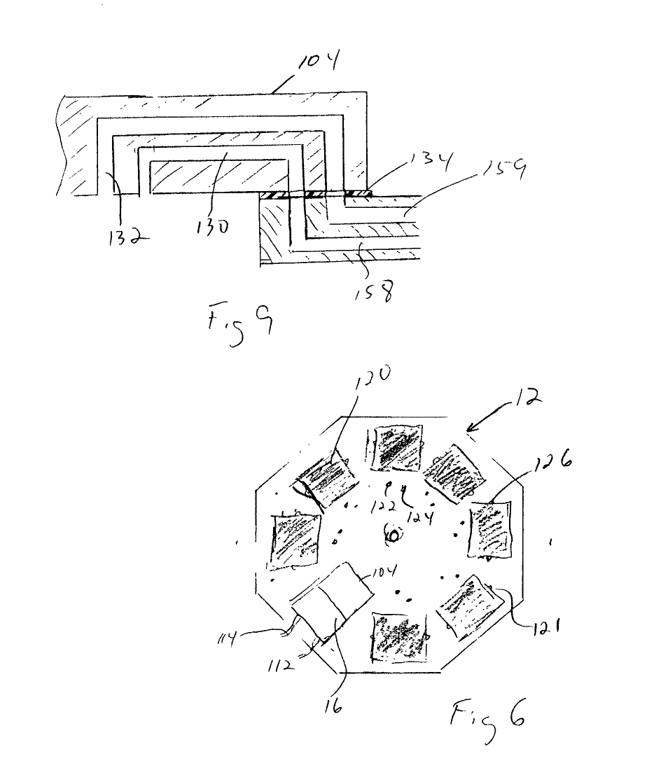

Referring to FIG. 1, a motor assembly 10 constructed in accordance with the invention is shown. The motor assembly 10 has a motor assembly housing or block 12 (FIG. 6) for housing a main power or drive shaft assembly 14. The motor assembly housing 12 is configured to receive one or more motor units designated generally at 16, 18 and 20, with each individual motor unit being designated with a letter notation (i.e. 16A, 16B, 16C, 18A, etc.).

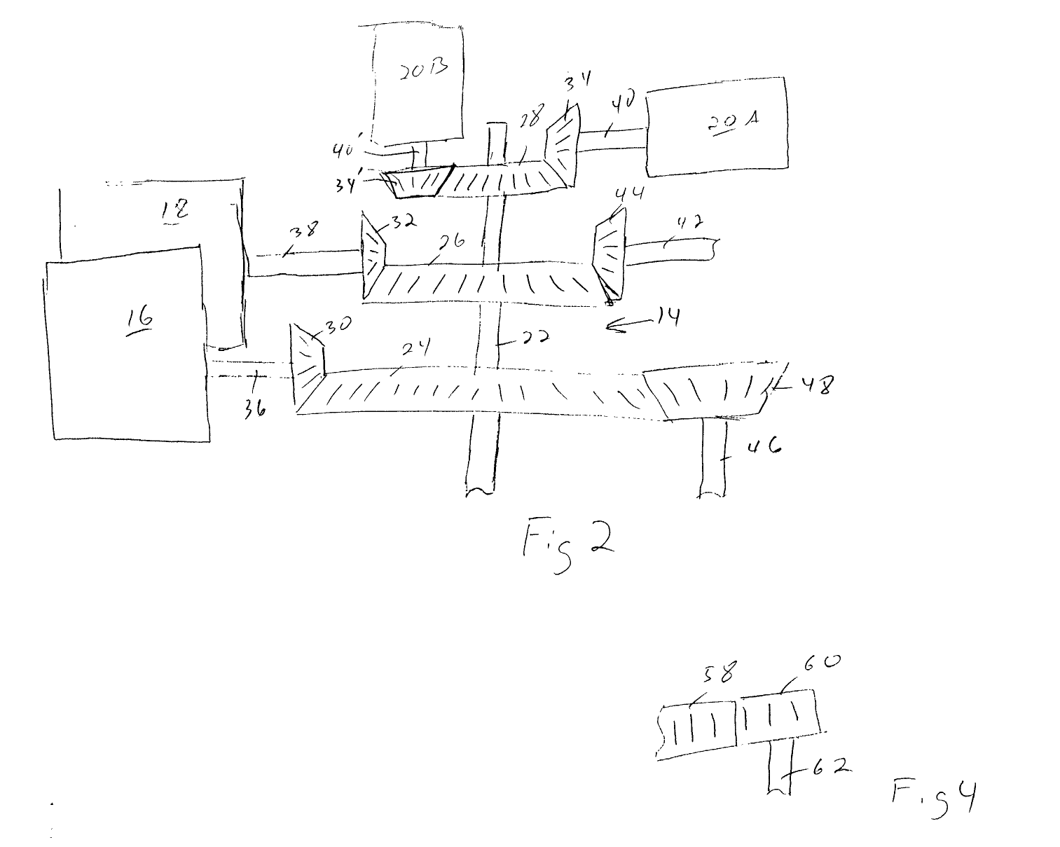

As shown, each of the motor units is generally disposed radially outward and circumferentially about the drive shaft assembly 14. The orientation and location of the motor units may be varied, however, as will be more readily apparent from the discussion that follows. Each of the motor units is substantially self-contained and independently operable from the other motor units. This facilitates installation, removal and replacement of the individual motor units for use in the motor assembly 10. This also allows motors of different types to be utilized. Thus, for example, the motor units 16A-16C may each utilize gasoline-powered engines, while motor units 18A-18C may employ diesel engines and motor units 20A, 20B (FIG. 2) may each utilize an electric motor. As contained herein, specific discussion or description to any particular motor unit may be given for exemplary or illustrative purposes, and it should be apparent to those skilled in the art that such description or discussion may have equal applicability to other motor units as well.

Referring to FIG. 2, the main power or drive shaft assembly 14 of the motor assembly 10 has a main drive shaft 22 rotatably mounted within the motor assembly housing 12. The main drive shaft 22 has a longitudinal axis that extends generally between opposite ends of the shaft 22, with the drive shaft 22 rotating about its longitudinal axis. Longitudinally spaced-apart drive shaft elements 24, 26 and 28, in the form of gears or toothed wheels, are coupled to the main drive shaft 22 and are rotatable about the longitudinal axis of the shaft 22 in a plane generally perpendicular to the shaft 22. The longitudinal spacing of the gears 24, 26, 28 allows the motor assembly 10 to be provided with several banks of motor units, such as the bank formed by motor units 16A-16C and the bank formed by motor units 18A-18C, with each bank of motor units engaging a different gear of the main shaft 22.

The gears 24, 26, 28 are shown in FIG. 2 as bevel gears having a generally circular-shaped outer periphery which engage intermeshing bevel gears 30, 32, 34 of the motor units 16, 18, 20, respectively. The gears 24, 26, 28 each have a different diameter, with the diameters increasing in size from the top to the bottom of the shaft in a generally tiered configuration. The different size gears allow different gear ratios to be utilized. Although the embodiment shown in FIG. 2 illustrates three gears of different diameters, any number of shaft elements or gears, being the same or different in size, may be provided along the length of the shaft 22 depending upon the design requirements and application of the motor assembly.

The motor gears 30, 32, 34 are coupled to drive shafts 36, 38, 40, respectively, each having a drive shaft axis about which the drive shafts 36, 38, 40 are rotatably driven by the respective motor units. The gears 30, 32, 34 are also bevel gears and may be the same or different in size to provide desired gear ratios. As shown in FIG. 2, the gears 30, 32 and 34 are configured and oriented so that the respective drive shafts 36, 38, 40 are perpendicular to the main shaft 22 when the gears 30, 32, 34 are engaged with gears 24, 26, respectively. Optionally, as shown in FIG. 2, the gear 34′ is shown configured and oriented so that its associated drive shaft 40′ of motor unit 20B is generally parallel to the main shaft 22 when the gear 34′ is engaged with gear 28.

The motor assembly 10 may be provided with other output shafts, in addition to the main drive shaft 22. FIG. 2 illustrates an output shaft 42 having a bevel gear 44 that is engaged with the gear 26 of the main shaft 22 and is shown as being perpendicular to the main drive shaft 22. An output shaft 46 having a bevel gear 48 is engaged with and driven by the gear 24 of the main shaft 22. The output shaft 46 is parallel to the main shaft 22.

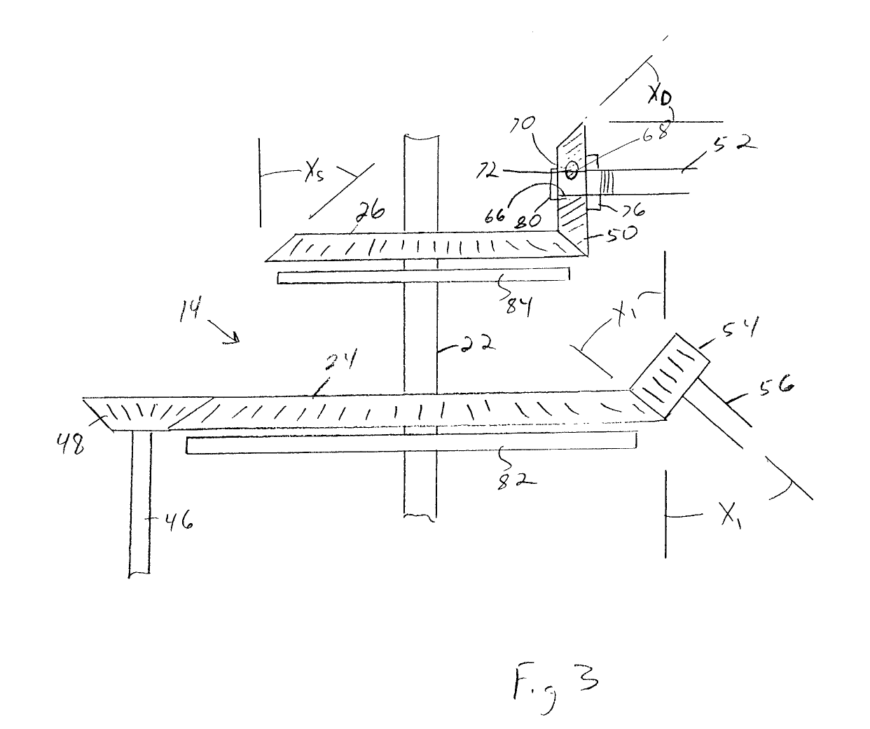

Although FIG. 2 shows various drive shafts engaged with the main shaft assembly 14 and being oriented at right or parallel angles to the main shaft 22 axis, they may be oriented in almost any orientation. Referring to FIG. 3, the drive shaft assembly 14 is shown with various drive or output shafts oriented at different angles. The angle of these shafts is determined by the contact interface of the gears used with the motor assembly. As shown in FIG. 3, the outer contact face of the bevel gear 26 is generally at an angle X_{S} with respect to the longitudinal axis of the shaft 22. The contact face of gear 50 of shaft 52 is at an angle X_{D} relative to the longitudinal axis of the shaft 52. By varying the angles X_{S} and X_{D}, which may the same or different, the drive or output shafts engaging the gears of the main drive shaft assembly 14 can be oriented at almost any angle, from 0 to 90°, relative to the longitudinal axis of the main shaft 22. Thus, for example, the gear 54, which employs a generally straight edge (i.e. X_{D}=0°) instead of a bevel, can be oriented at an angle X₁, which is equal to the angle of the beveled gear 24 (i.e. X₁=X_{S}).

FIG. 4 shows another embodiment wherein a gear 58 of the main shaft 22 is a straight-edge gear (i.e. X_{S}=0°) and the gear 60 of the shaft 62 is also straight (i.e. X_{D}=0°) such that both shafts 22 and 62 are oriented parallel to one another when the gears 58 and 60 are fully engaged.

Each of the gears of the drive shafts and output shafts that are engaged with the main power shaft assembly 14 are rigidly coupled to their respective shafts. This may be accomplished through the use of a slot and key arrangement, as illustrated in FIG. 3 with respect to gear and shaft 50, 52. It should be apparent to those skilled in the art that the same construction could be used for the remaining gear and shaft assemblies utilized in the motor assembly, and while a particular construction has been illustrated and described, other constructions could be used as well. As shown, the gear 50 is mounted over the shaft 52 by means of central bore 66. Key slots 68, 70 formed in the shaft 52 and central bore 66 of the gear 50, respectively, are provided for receiving a key 72 to prevent relative rotation of the gear 50 and shaft 52, but permitting longitudinal movement of the gear 50 along the shaft 52. A portion of the shaft 52 is externally threaded for receiving an internally threaded thrust washer 76, which is mounted thereon. Tightening of the thrust washer 76 facilitates meshing engagement of the gear 50 with the main shaft gear 26. The thrust washer 76 is loosened to facilitate disengagement of the gear 50 with main shaft gear 26. A gear retaining member 80 is provided on the end of the shaft 52 to retain the gear 50 upon the shaft 52.

The main shaft elements or gears may be rigidly joined to the main shaft 22 to thereby cause rotation of the main shaft 22 about its longitudinal axis by rotation of such gears. Preferably, however, the main shaft gears are disengageable from the main shaft so that the gears can be selectively engaged with the main shaft 22. This may be accomplished through the use of a clutch mechanism, such as the clutch plates 82, 84, shown in FIG. 3. The clutch plates 82, 84 are coupled to the main shaft 22. The clutch plates 82 may be actuated by those methods known to those skilled in the arts, such as by hydraulic or mechanical means. The clutch plates 82, 84, when actuated, will engage the shaft gears 24, 26, respectively, so that the shaft gears 24, 26 engage and rotate the main shaft 22. When the clutch plates 82, 84 are disengaged from the gears 24, 26, the shaft gears 24, 26 are disengaged from the main shaft 22 and are free to rotate about the longitudinal axis of the main shaft 22.

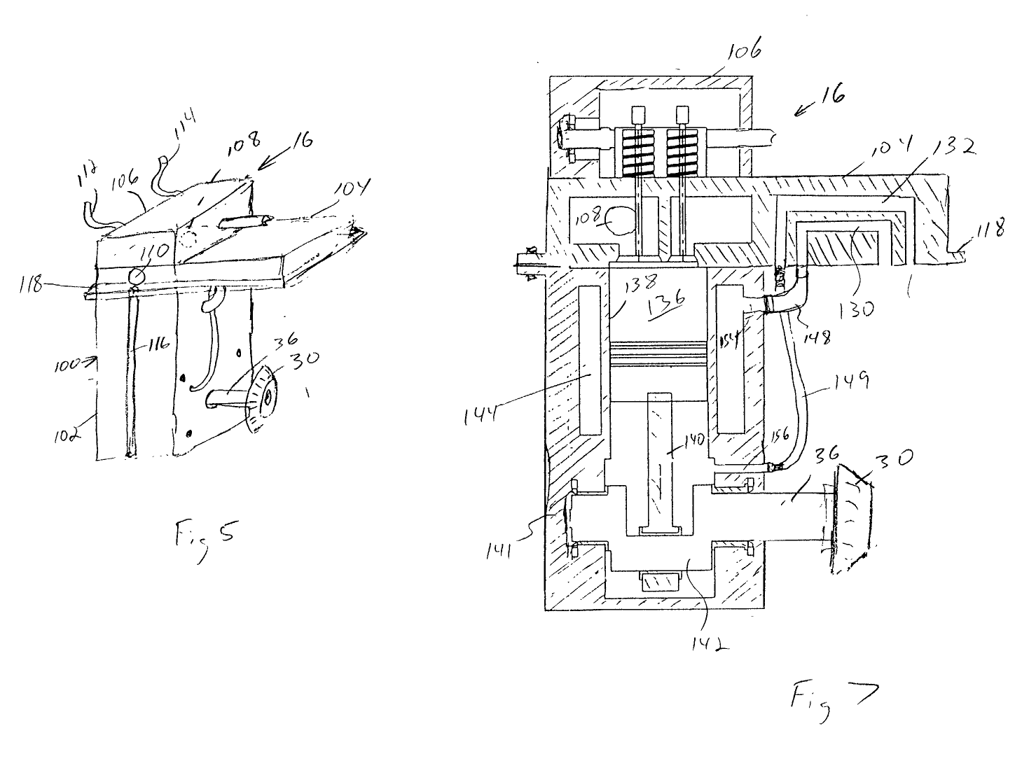

Referring to FIG. 5, a motor unit module 16 is shown. The motor unit 16, which, in this instance, is a combustible fuel engine, is substantially self-contained and housed in a block housing 100. The housing 100 consists of a main housing 102, which houses internal components of the engine. A mounting block 104 of the housing 100 is joined to the upper portion of the main housing 102. A cam housing 106, joined to the mounting block 104, is also provided for housing internal components of a cam assembly of the engine. Fluid ports, such as the air intake and exhaust ports 108, 110, are provided in the block housing 100. Additional fluid ports, for cooling fluid and oil, are formed in the mounting block portion 104 of the housing 100 and are positioned to correspond to fluid ports formed in the motor assembly housing 12, as is discussed more fully below. A spark plug wire 112 from a distributor or electrical firing system is releasably connected to the mounting block 104, if necessary. A fuel line 114 from a fuel supply source is also connected to the block housing for supplying fuel to the engine of the motor unit 16. Preferably, the fuel line 114 is connected by means of a quick-release-type coupling so that it can be easily connected and disconnected, when removing or installing the motor unit 16. The drive shaft 36 and gear 30 extend outward from the housing block 100 for engagement with the main shaft gear.

Guide members 116 formed along the exterior of the main housing 102 may be provided to facilitate installation of the motor unit 16 into the motor assembly housing 12. A mounting flange 118 extending around the perimeter of the mounting block 104, having bolt holes formed therein, may also be provided to facilitate fastening of the motor unit 16 to the motor assembly housing 12.

As shown in FIG. 6, the motor unit housing 100 for each motor unit is received within a motor unit receiver 120 formed in the motor assembly housing or block 12. The motor assembly housing 12 may be provided with a plurality of such receivers 120 for receiving several motor units for the motor assembly 10. The motor unit receivers 120 may be circumferentially spaced apart around the main shaft assembly in a generally circular or semi-circular arrangement. The receivers 120 may be configured the same or differently depending upon the type of motor units employed with the motor assembly 10. The motor unit receiver 120 should be configured to allow the passage of the gear 30 and drive shaft 36 through the opening of the receiver 120 and into engagement with the main shaft gear with which it is associated. Slots or grooves 126 that correspond to the guide members 116 may be formed in the receiver 120, so that the motor unit 16 is guided and properly positioned within the receiver unit 120.

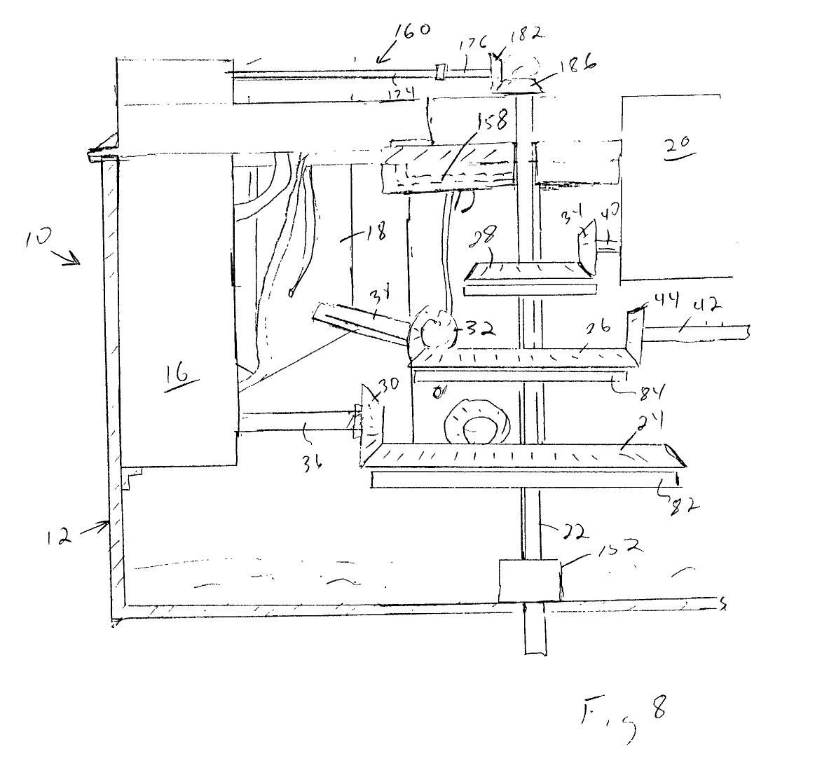

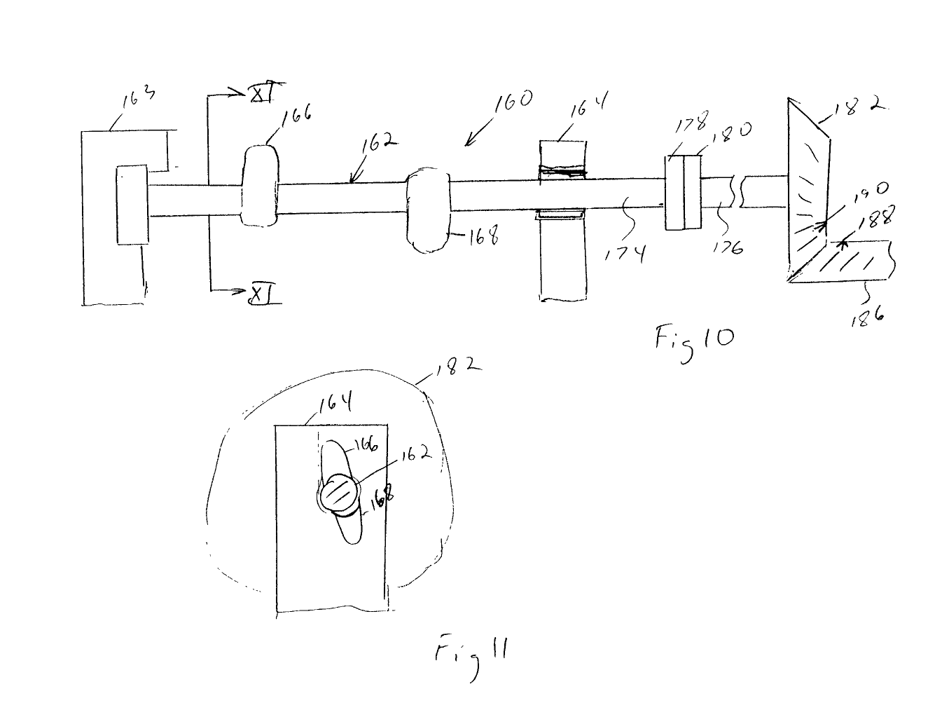

When the motor unit is positioned within the receiver 120, the motor unit is secured to the motor assembly housing 12 by bolting the mounting block 104 to a mounting surface 121 of the motor assembly housing 12. Referring to FIGS. 7 and 8, fluid ports, such as ports 122, 124, for cooling fluid and oil, are formed in the motor mounting surface 121 of the assembly housing 12. The fluid ports 122, 124 are positioned and configured to correspond to oil and cooling fluid ports 130, 132 formed in the mounting block 104 when the motor unit housing 100 is fully received within the receiver 120. A gasket 134 (FIG. 9) may be positioned between the mounting block 104 and surface 121 to provide a fluid-tight seal between the fluid ports of the motor unit and motor assembly housing 12.

The description which follows is made with respect to the motor unit 16, which is shown as a combustible fuel powered motor unit. Although, one particular construction is shown and described, it should be apparent to those skilled in the art that other motor units having different constructions could be utilized as well, and in no way should the following description be construed to limit the scope of the invention.

Referring to FIG. 7, the motor unit 16 is provided with an engine formed from a piston 136 and cylinder 138 disposed within the interior of the housing 100. A piston rod 140 joins the piston 136 to a crank 142 of the drive shaft 36 in a conventional manner. The drive shaft 36 is mounted to oppositely disposed mounting blocks 141, 143. The mounting blocks 141, 143 may be provided with bearing assemblies to allow free rotation of the drive shaft 36. In the embodiment shown, the motor unit 16 is provided with a single piston and cylinder arrangement for rotating the drive shaft 36. It should be noted that more than one piston and cylinder could be employed, however, for each motor unit to drive its respective crank or drive shaft.

The mounting block 102 is bolted to the main housing 102 and forms a cylinder head 146 of the cylinder 138. A water or cooling fluid jacket 144 is formed within the housing 100 and surrounds the cylinder 138. Cooling fluid is supplied to the jacket 144 from fluid port 130 through hose 148 and port 154, formed in the main block 102 of the motor unit 16. The hose 148 may be connected to the port 132 by means of quick-release couplings, if desired, to facilitate removal and installation. Additionally, an oil line 149 connected to the oil port 132 supplies oil to the motor unit 16. The oil line 149 is connected to port 156 formed in the main housing 102. The oil line 149 may be connected to the ports 132, 156 by means of quick-release couplings.

Referring to FIG. 8, an oil reservoir is formed in the lower portion of the motor assembly housing 12. An oil pump 152 coupled to and powered by the main shaft 22 provides pressurized oil to the main power shaft assembly 14, and to the individual motor units by means of the conduit 158 formed in the motor assembly housing 12 and fluid ports 130. A water or cooling fluid pump (not shown) may also be powered by the main shaft 22 to provide cooling fluid to all the motor units. Conduits 159 (FIG. 9) formed in the motor assembly housing 12 are provided for this purpose.

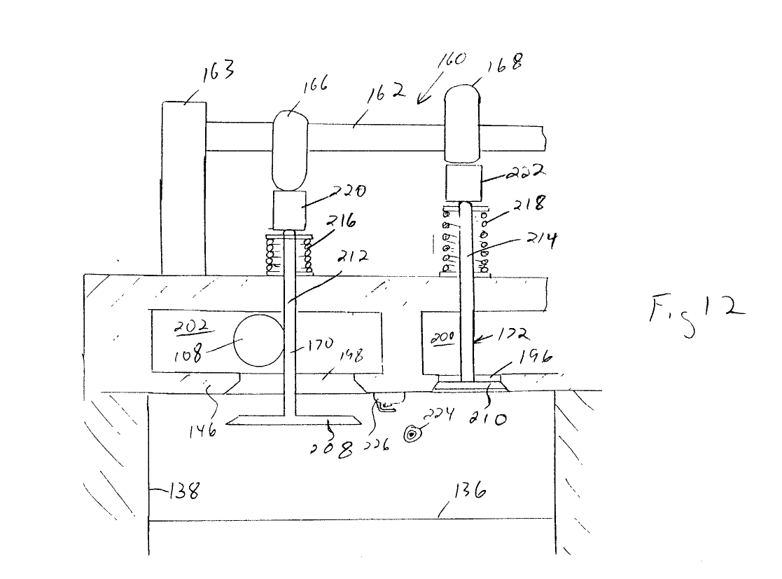

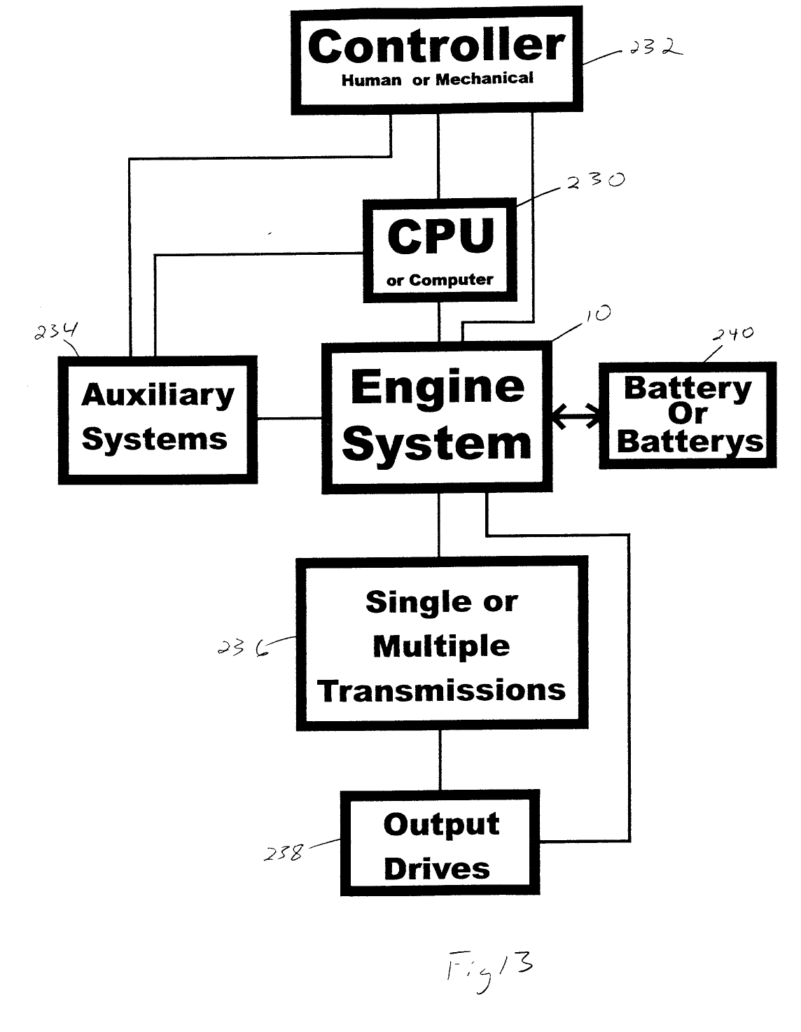

Referring to FIG. 10, a suitable cam assembly 160 is shown for operating valves of the motor unit 16. The cam assembly 160 is housed within the cam housing 106 and includes a camshaft 162 that is rotatably mounted to supports 163, 164. Located along the length of the camshaft 162 are cams 166, 168. As shown in FIGS. 10 and 11, the cams 166, 168 are oriented and shaped to provide the proper sequencing and displacement necessary for proper operation of intake and exhaust valves 170, 172 (FIG. 12) of the motor unit 16. The camshaft 162 is formed into two sections 174, 176, with section 174 being mounted to supports 163, 164. The section 176 is coupled to section 174 by means of coupling members 178, 180, which are bolted together so that the two sections 174, 176 may be separated. Mounted on the end of camshaft section 176, opposite coupling member 180, is a cam gear 182. The cam gear 182, which is shown as a bevel gear, engages a timing gear 186 that drives the camshaft 162. The timing gear 186 is mounted to and rotatably driven by the main shaft 22 (FIG. 8). The cam gear 182 and shaft section 176 may be similarly constructed as the gear and shaft 50, 52, previously discussed, to ensure that the gear 182 is fully engaged and intermeshes with gear 186. Proper timing of the cam assembly is achieved by aligning indicia 188, 190 provided on the timing gear 186 and cam gear 182, respectively. In this way, the various motor units can be timed for smooth operation of the motor assembly 10.

Referring to FIG. 12, formed in the cylinder head 146 are exhaust and intake ports 196, 198. The exhaust port 196 is connected to exhaust chamber 200 formed in the mounting block 104 where combustion products are exhausted through port 110. Air or oxygen for combustion is introduced into the cylinder 138 through intake port 108, through chamber 202 formed in the mounting block 104 and through intake port 198. Valves 170, 172, consisting of valve heads 208, 210 and valve stems 212, 214, respectively, are mounted to the cylinder head 146. The valves 170, 172 are biased to the closed position for sealing off ports 198, 196, respectively, by means of compressed coiled springs 216, 218. Rocker arms 220, 222 are provided for engaging the valve stems 212, 214 and are actuated by means of the cams 166, 168 as the camshaft 162 is rotated.

Fuel is introduced within the cylinder 138 through fuel injection nozzle 224 mounted to the cylinder head 146. The fuel nozzle 224 is connected to a fuel supply system (not shown) by the fuel line 114, which is connected to an accelerator or similar control for adjusting the amount of fuel supplied to the motor unit. A spark plug 226 connected to wire 112 (FIG. 5), may also be provided to initiate firing of combustible fuel mixtures introduced into the cylinder 138. Firing of the individual motor units may be accomplished through a distributor, magneto or sensor operated firing mechanism, which are well known to those skilled in the art.

Because the motor units, such as the motor unit 16, of the motor assembly 10 are substantially self-contained and generally independently operated, they are easily removed and replaced, and can be interchanged with other motor units, without significantly affecting the operation of the motor assembly 10. Because the main drive shaft assembly 10 is driven by a plurality of drive shafts driven by different motor units, it is possible for the motor assembly to continue operating even with the malfunction or removal of one or less than all the motor units.

To install one of the motor units, such as the motor unit 16, the motor unit 16 is placed within one of the motor unit receivers 120. In the embodiment shown in FIG. 2, the motor assembly is provided with three main shaft gears 24, 26, 28, which are driven by the motor units 16, 18, and 20, respectively. As can be seen, the lower gear 24 is greater in diameter than the center gear 26. Likewise, the center gear 26 is greater in diameter than the upper gear 28. This configuration allows the motor units to be more easily positioned within the receiver motor assembly housing 12. It allows the motor units or banks of motor units to be arranged in a stacked or tiered configuration, with a single motor unit or bank of motor units being positioned above another. Thus, when the motor unit 16 is introduced into a motor unit receiver 120, the drive shaft 36 and gear 30 are provided with a clearance by the smaller diameter gears 18 and 20 positioned above, so that it can be more easily positioned into engagement with the lower gear 24.

The same is true with respect to the motor unit 18 and its drive shaft 38 and gear 32 being provided a clearance by the smaller upper gear 28 of the main shaft assembly 14, when it is lowered into engagement with the main shaft gear 26. While the use of smaller gears nearer the opening of the receiver 120 may facilitate installation of the motor units, as has been previously discussed, the gear or shaft elements of the main shaft assembly 14 may be of the same or different sizes.

As the motor unit 16 is lowered into the motor unit receiver 120, the guide members 116 will slide within slots 121 to guide the motor unit into position with the receiver 120. A support 228 (FIG. 8) may be provided within the receiver 120 for supporting the lower portion of the main housing 102. It is preferable that the motor units for each bank be standardized or otherwise constructed so that the drive shaft and gear of each motor unit will readily engage the associated gear of the main shaft assembly when the motor unit is fully received within one of the receivers 120, without significant alteration or adjustment of the drive shaft or drive shaft gear of the motor unit.

When the motor unit 16 is mounted within the receiver 120, the gear 30 should be fully intermeshed with the gear 24. This may be accomplished by adjusting or tightening the lockable thrust washer, such as the thrust washer 76 described previously, provided with the gear 30. If necessary, closeable access points (not shown) communicating with the interior of the receivers 120 may be provided at various positions in the motor assembly housing 12 to facilitate installation of the motor units.

The camshaft assembly 160 is then coupled to the motor assembly by engaging the cam gear 182 with the timing gear 186, making sure the indicia 188, 190 are aligned to ensure proper timing. The couplings 178, 180 allow the camshaft sections 174, 176 to be disconnected if necessary to facilitate installation. It should be noted, that although the particular camshaft assembly 160 is shown, other cam assemblies that operate in a different manner can be utilized as well.

As the motor unit is lowered into the receiver 120, the mounting block 104 is positioned so that it rests on the mounting surface 121 surrounding the receiver opening, and so the fluid ports 122, 124 formed in the mounting surface 121 are aligned and in communication with the respective fluid ports 130, 132, with the gasket 134 providing a fluid-tight seal. The mounting block 104 is then bolted or otherwise fastened to the motor assembly housing 12 so that the motor unit 16 is secured thereto. Preferably, the receiver and corresponding motor unit should be configured so that when the motor unit is positioned within the receiver of the motor assembly housing 12, the fluid ports will automatically be in alignment without necessitating shifting or further adjustment of the motor unit within the receiver.

If an electric motor unit is employed, the installation may be much simpler, since fluid connections and engagement of a cam assembly are eliminated. The installation of an electric motor unit is generally the same as for motor unit 16 with respect to the drive shaft and gear. The mounting block of the electric motor unit will lack the fluid ports, such as the fluid ports 130, 132, and should completely cover and seal off any fluid ports formed in the mounting surface 121 of the motor assembly housing 12. The electric motor unit is connected to a battery or other electrical power source. Control means for regulating the power supplied by the battery or power source is also provided.

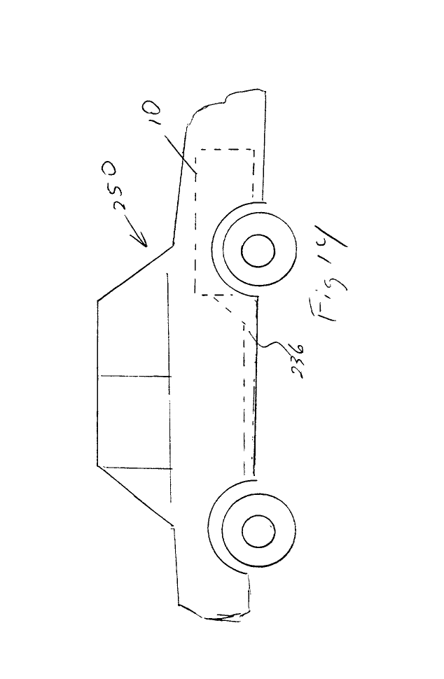

FIG. 13 is a general schematic showing how the motor assembly can be employed in a motorized system 228, such as an automobile. The motor assembly 10 may be connected to a central processing unit (CPU) or computer 230 for controlling its various components. A controller 232 is provided for inputting instructions to the CPU for operation of the motorized system 228. The CPU 230 may also be connected to an auxiliary system 234 and main drive transmission 236. Both the auxiliary system 234 and transmission 236 are coupled to and powered by the motor assembly 10. Either or both the auxiliary system 234 and transmission may be coupled directly to and driven by the main drive shaft 22 of the motor assembly 10, or alternatively by an output shaft, such as one of the output shafts 19 or 21, illustrated in FIG. 1. The auxiliary system 234 is representative of a wide variety of different systems. These could include such things as air conditioning or cooling systems, electric generators, hydraulic systems, pumps, compressors, cranks, wenches, blowers, etc. While only one auxiliary system 234 is shown, there may be one or more such auxiliary systems. As has been discussed, the motor assembly 10 can be provided with any number of output shafts to power or drive such auxiliary systems.

The motor assembly 10 is also connected to a primary drive system 238 through the transmission 236. The primary drive 238 may be a propulsion system, such as the wheels or axel of an automobile, or a propeller of a plane, ship or boat, or a stationary system, such as a stationary generator, compressor, pump, etc. The transmission 236 is provided so that different gear ratios may be selected to provide the necessary power or r.p.m.'s to the primary drive 238 and so that the system 228 operates more efficiently. Although not shown, the auxiliary system 234 may also be connected to the motor assembly 10 through a transmission system as well.

Both the auxiliary system 234 and transmission 236 may be connected to the CPU 230 so that input to and feedback from these systems is provided to the CPU. The controller 232 may also be connected directly to the auxiliary system 234, motor assembly 10 and transmission 236, if necessary.

A battery unit 240 is also connected to the motor assembly 10. The battery 240 may be connected to a starter for the motor assembly 10 if the motor assembly employs combustible fuel engine motor units, or to one or more electric motors of the motor assembly 10, when such motors are employed for powering electric motor units. When both combustible fuel engine and electric motor powered motor units are employed, the electric motor unit(s) powered by the battery unit 240 may serve as both a starter for rotating the main shaft 22 to thus start the combustible fuel engine motor units and to supply power to the main shaft assembly 14.

The battery unit 240 may also be recharged during the operation of the motor assembly 10. In such cases, a separate generator (not shown) may be provided with and powered by the motor assembly for recharging the battery unit 240, or electric motors of electric motor units may be employed. In the later case, one or more motor units employs a motor that is both an electric motor and a generator. This is preferably the case when a hybrid motor assembly is used that employs both combustible fuel powered motor units and electric motor units. During different modes of operation, the electric motor can either provide power to the motor assembly or be powered by the motor assembly to serve as a generator to recharge the battery unit 240.

The motor assembly has particular application as a hybrid motor, utilizing both combustible fuel engines and electric motors. For example, referring to FIG. 2, the motor assembly 10 is shown with three different motor units 16, 18, 20 engaging the main shaft assembly 14. Each of these motor units may be powered differently, with motor unit 16 being powered by a gasoline engine, motor unit 18 being powered by a diesel engine and motor unit 20 being powered by an electric motor. Although one of each of the differently powered motor units is shown in FIG. 2, there may be several of each motor units similarly arranged in banks or rows, as shown in FIG. 1.

During high torque applications of the motor assembly 10 or when battery power is low or depleted, the combustible fuel powered motor units 16 and 18 may supply most, if not all of the power, to the main shaft 22 of the shaft assembly 14. In such cases, the CPU 230 may monitor the power or torque required so that the combustible fuel powered motor units 16, 18 are engaged with the main shaft assembly 14 for rotating the main shaft. This may be accomplished through the operation of the clutch mechanism shown in FIG. 3, wherein the main shaft gears of the shaft assembly 14 are selectively engaged with the main shaft 22. Because the motor units employ separate drive shafts and gears that engage one of the main shaft gears, with each potentially having a different gear ratio, the motor units may be operated at different speeds with the drive shafts rotating at completely different rates.

When the main shaft assembly is powered by the combustible fuel powered motor units, the gear 28 engaged with the motor unit 20, which would employ an electric motor/generator, would remain engaged with and be driven by the main shaft 22. The CPU would switch the motor unit 20 to a power generation mode wherein the gear 28 is rotated by main shaft 22 and rotates the drive shaft 40 of motor unit 20 so that electrical power is generated and supplied to the battery 240. In this way, the battery or batteries 240 can be recharged for later use.

In low torque applications or when battery power alone is sufficient to power the motor assembly 10, the main shaft gears 24, 26 that are powered by the combustible fuel engine motor units 16, 18, are disengaged by means of the clutch mechanism. The combustible fuel powered motor units can then be allowed to idle or be shut off completely, if desired. As discussed previously, the electric motor unit(s) 20 rotating the main shaft 22 could also act as a starter for starting the combustible fuel engine motor units 16, 18 when they are needed. This would be accomplished by engaging the main shaft gears 24, 26 with the main shaft 22, through the use of the clutch mechanism, so that the gears 24, 26 drive and rotate the drive shafts 36, 38 to thus turn and start the engines of the motor units 16, 18, respectively.

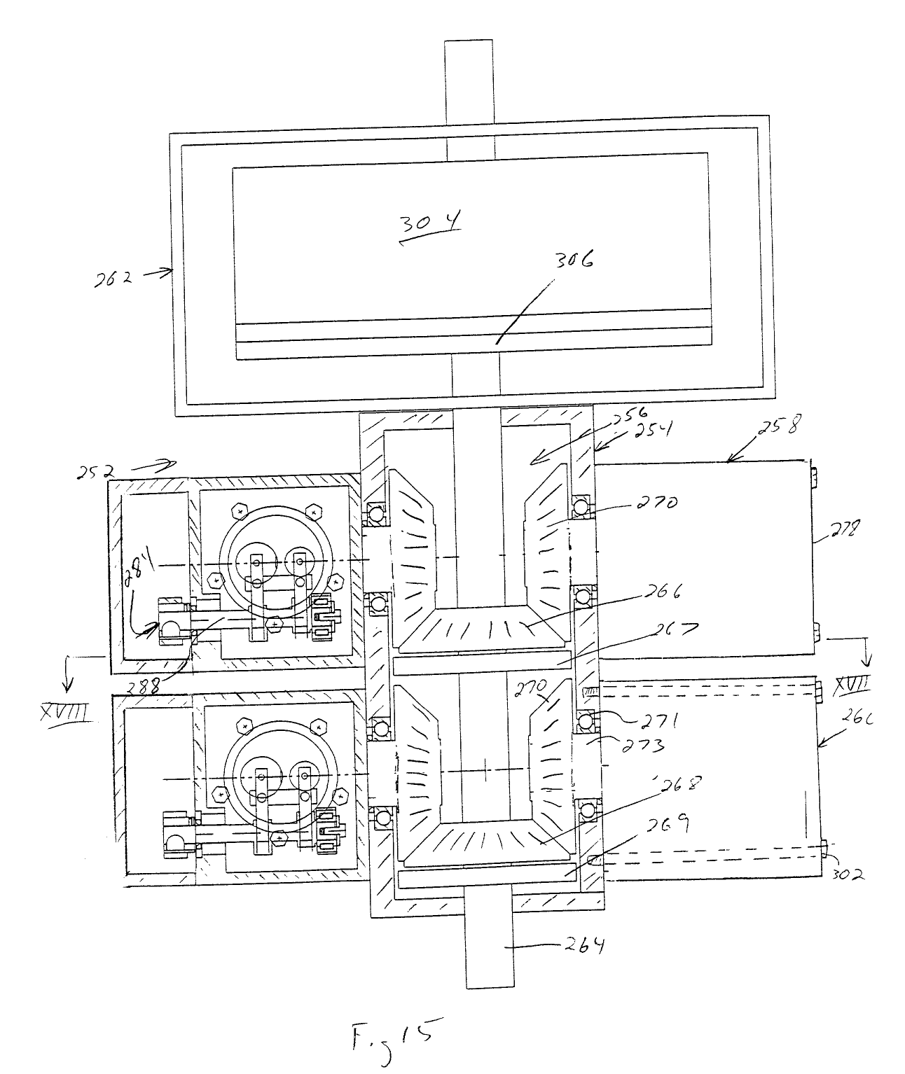

The electric motor units employed with the motor assembly 10 can also be used to facilitate braking operations, such as for the stopping or slowing of wheeled vehicles, such as the hybrid-powered automobile 250 of FIG. 14. In such cases, referring to FIG. 13, input from the controller 232, which may include the application of a brake pedal by an operator, may cause the engagement of conventional friction-type brakes for slowing the vehicle. Additionally, input from the controller 232 during braking operations may be sent to the CPU 230, which causes power to be cut from the battery 240 supplied to the electric motor units 20 of the motor assembly 10 and causes the motor units 20 to switch to an electric generator mode. In such mode, the electric motor units 20 remained engaged with the main shaft assembly 14, with the gear 28 still engaged with the main shaft 22 by means of its clutch mechanism. Thus, energy from the continued rotation of the main shaft 22 as the vehicle is slowed is translated into energy for charging the battery 240, as the main shaft causes the motor unit 20 to generate electrical energy by rotation of the drive shaft 40.

In this way, braking is facilitated and much more efficient, actually converting energy that would otherwise need to be dissipated as heat into useful electrical energy that can be stored and utilized later.

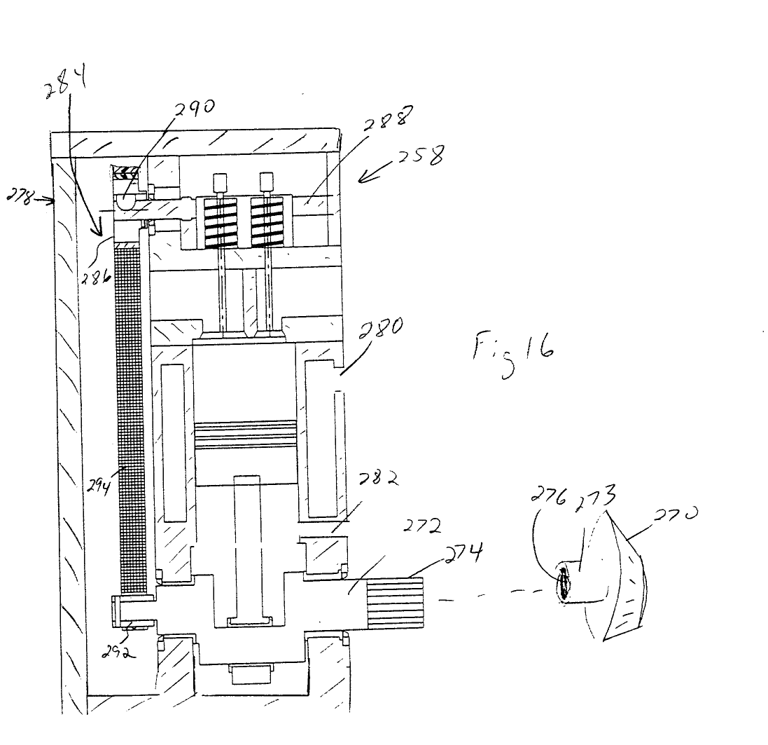

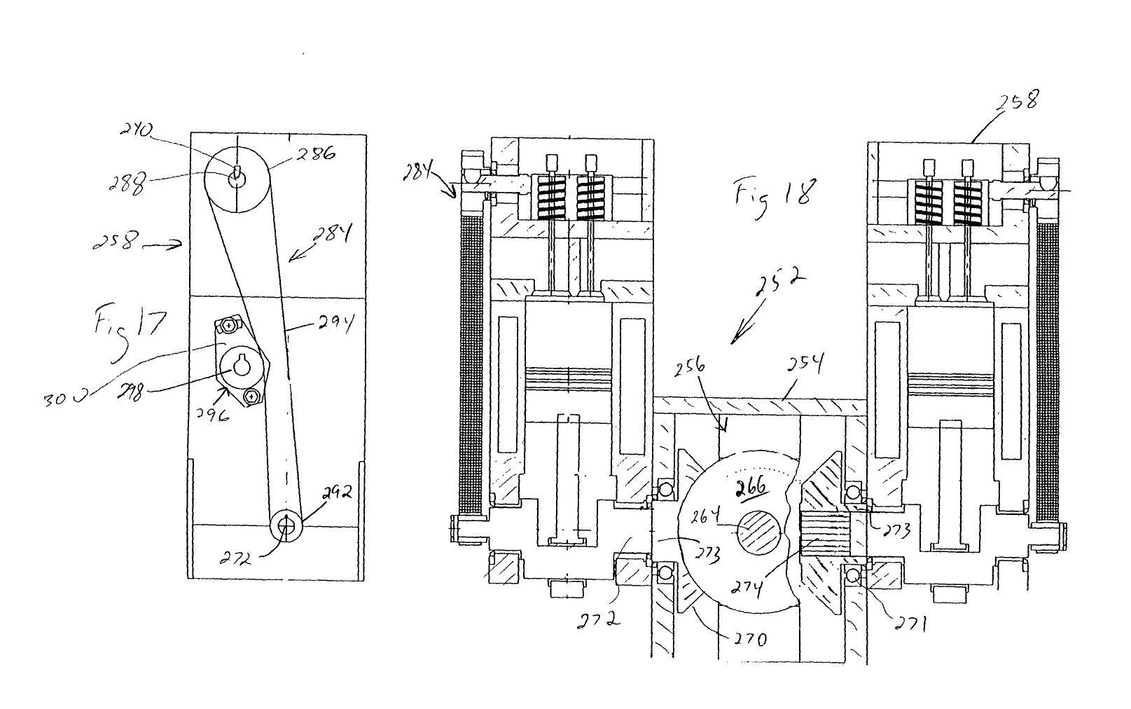

Referring to FIGS. 15-19, another embodiment of a motor assembly 252 is shown. The motor assembly 252 has particular application for use in the standard engine compartment of many automobiles. The motor assembly 252 is similar to the motor assembly 10, previously described, but with certain variations, as will be apparent from the following discussion.

The motor assembly 252 is provided with a motor assembly housing or block 254. A main power shaft assembly 256 is housed within the block 254. The exterior of the motor assembly housing 254 defines receiving areas for receiving motor units, such as the motor units 258, 260. The motor units 258, 260 are shown as being combustible-fuel-engine motor units, each being of substantially the same construction. It should be apparent, however, that the motor units 258, 260 may also be different in construction. Provided at one end of the motor assembly is an electric motor unit 262.

The main shaft assembly employs a main shaft 264 having longitudinally spaced apart shaft gears 266, 268, each having a clutch plate 267, 269 for selectively engaging the gears 266, 268 with the main shaft 264. Mounted to the assembly housing 254 and engaged with the gears 266, 268 is a drive shaft gear 270. The drive shaft gear 270 is rotatably mounted within the housing or block 254 by means of a bearing assembly 271, which surrounds a neck 273 of the gear 270. The gear 270 is fully engaged and intermeshed with the shaft gear 266, 268 with which it is employed, so that no need for tightening or adjusting is necessary when mounting the motor units, as will be described.

The motor units 258, 260 are similar in construction to the motor unit 16, described previously. The end 274 of the drive or crankshaft 272 is provided with longitudinal splines, or is otherwise contoured, for being received within a corresponding splined area 276 of the neck 273 of gear 270, to prevent relative rotation of the gear 270 and shaft 272, but permitting longitudinal movement of the crankshaft end 274 into the neck 273. Preferably, the splines of the drive shaft end 274 and neck 273 are configured so that the drive shaft 272 and gear 270 are coupled together in only a single relative orientation that corresponds to a proper timing mode of the motor assembly, as is addressed below.

As shown in FIG. 16, the motor unit 258 has a housing 278 that surrounds the engine of the motor unit. The housing 278 may be provided with a cooling fluid port 280 and an oil port 282 that may engage fluid ports (not shown) of the motor assembly housing 254. It should be apparent, however, that cooling fluid and lubricating oil could be introduced elsewhere, if desired. As can be seen, in the motor unit 258, the overhanging mounting portion of the motor unit housing is eliminated, with the housing being generally of a rectangular box construction.

A different cam drive assembly 284 is also provided and entirely housed within the motor unit housing 278. The cam drive assembly 284 utilizes an overhead cam pulley 286 that is mounted to the camshaft 288. A key 240 prevents relative rotation of the cam pulley 286 with respect to the camshaft 288. A wheel 292 is similarly joined to the end of the crankshaft 288 opposite the crankshaft end 274. A continuous belt 294 is mounted and passes over the wheels 286, 288. It should be noted that a continuous chain and sprockets could be similarly employed as well. A tensioner assembly 296 is used to tighten the belt 294 to prevent slippage of the belt about the wheels 286, 288. The assembly 296 is provided with an idler wheel 298 that engages the belt 294. A mounting bracket 300 that can be adjusted for engaging or retracting the idler wheel 298 for tightening or loosening the belt 294 is provided. This allows easy installation and removal of the belt 294.

Because the splined shaft 272 and gear 270 can only be oriented in a single orientation, and the cam drive assembly 284 is contained within the motor unit housing and is directly driven by the crankshaft 272, it can be preset to a properly timed positions so that there is no need to make adjustments to ensure proper timing of the motor units of the motor units during their installation. Piston placement within the individual motor units and the firing order is thus determined by the gears 270 in motor housing for each of the motor unit receiving areas. Thus, there is no need to adjust the timing of the motor units during installation of the individual motor units.

Motor units 258, 260 are quickly installed by merely inserting the splined end 274 into the corresponding splined area 276 of the neck 273 and bolting the motor unit to the exterior receiving area of the motor assembly housing 254 by means of bolts 302 (FIG. 15). Any necessary fluid connections, such as fuel lines or spark plug wires can then be connected to the motor unit in a similar manner as was described with respect to motor unit 16.

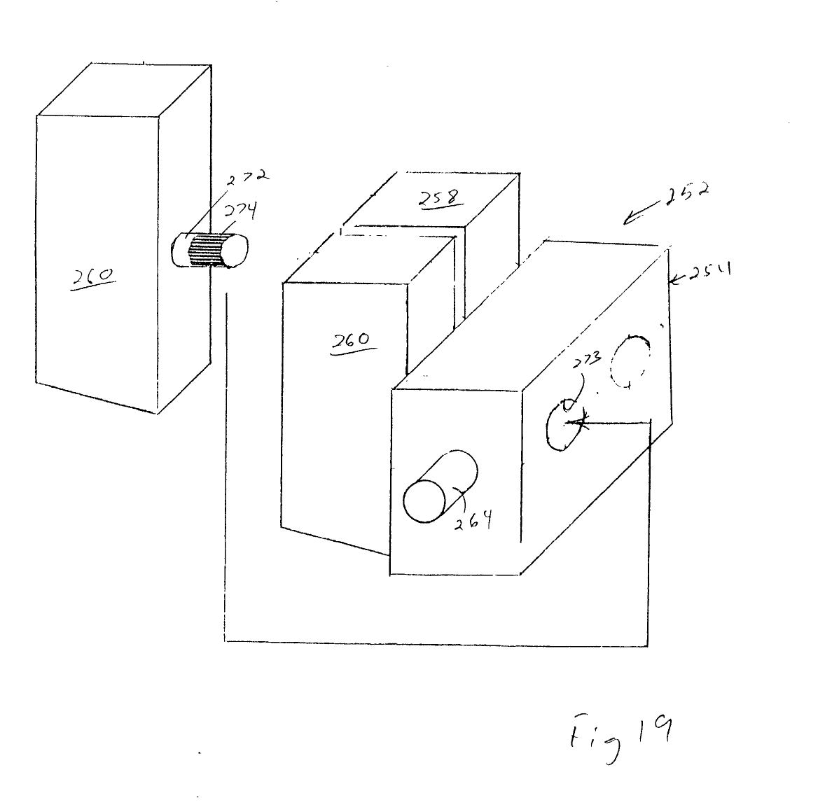

Referring to FIG. 18, the motor units are oriented so that the piston and cylinder of the motor units are generally perpendicular to the longitudinal axis of the main shaft 264. This is similar to many of those conventional engines or motors used in many automobiles and is contrasted with the motor assembly 10, wherein the piston and cylinders of the motor units were oriented generally parallel with the longitudinal axis of the main shaft and in a circumferential relationship.

In the particular embodiment shown in FIG. 15, four combustible-fuel-powered motor units are employed, two on either side of the main shaft 264, to provide a four-cylinder motor assembly. The motor units may employ standard size piston and cylinders, similar to those used in most automobiles so that the motor assembly 252 is generally of the same size and configuration of many conventional automobile engines and can be adapted to be received in most automobile engine compartments. Thus, for example, the cylinders of the four motor units may provide volume of from 1000 to 2500 cc, which is a typical engine size for many conventional four-cylinder automobile engines.

The motor assembly 252 is shown as a hybrid, wherein a single electric motor unit 262 is employed as well. The motor unit 262 employs an electric motor 304 that is engaged with the main shaft 264 by means of a clutch 306. The electric motor is of a size to provide adequate power to an automobile, when used in conjunction with the combustible-fuel-powered motor units. A suitable electric motor would provide a horsepower of from 50 to 75 hp. The operation of hybrid engines is described previously and would have similar application to the motor assembly 252.

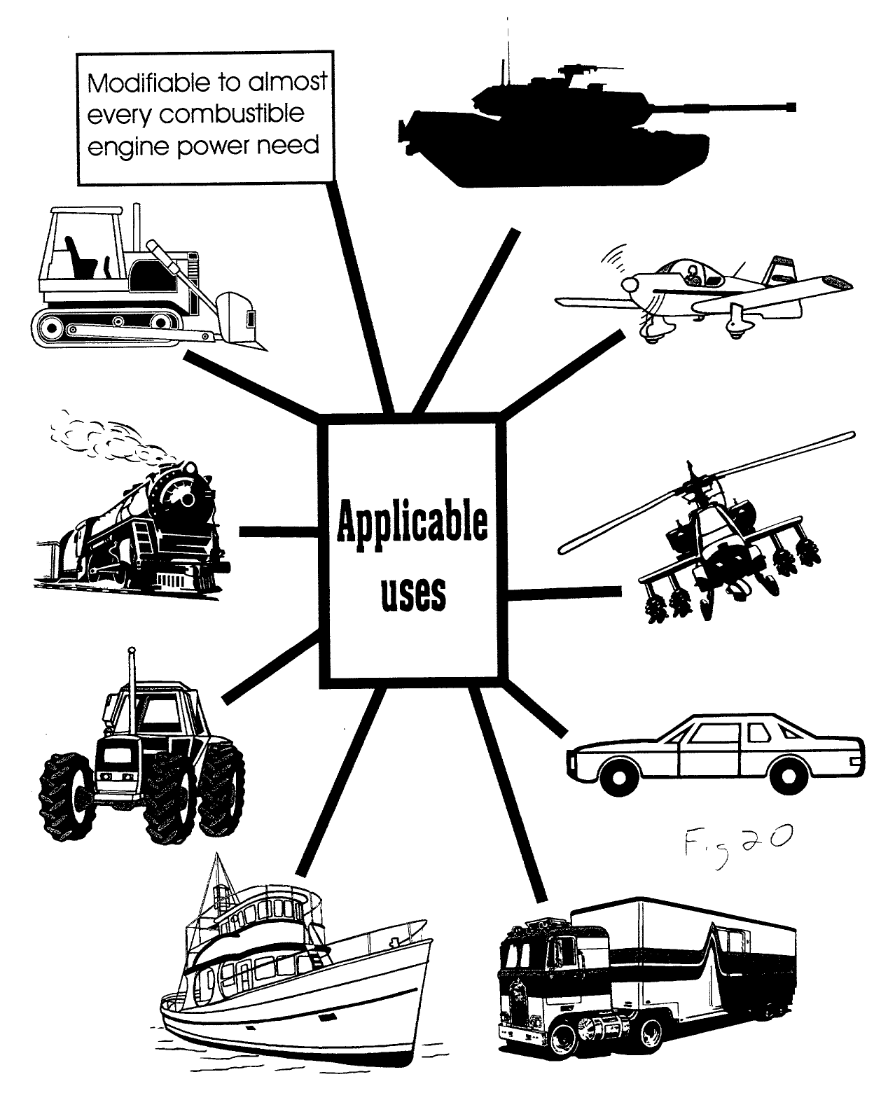

FIG. 19 shows how the motor units 258 and 260 interrelate with the motor assembly housing 254. The motor units are installed by merely inserting the splined shaft 272 into the neck 273 of the gear 270 housed within the motor assembly housing 254 and securing the motor units to the housing 254.

The invention has many advantages over the prior art. Because the motor assembly main drive shaft is powered by one or more motor units, each being independently operated and having its own drive shaft, the motor assembly can still be operated with less than all of the motor units. Thus, when a motor unit has failed or becomes nonfunctional, the motor assembly can still be operated. This provides an enormous safety feature, particularly where failure of the engine or motor would otherwise be life threatening, such as on busy highways or on open seas.

FIG. 20 illustrates some of the applications of the motor assembly of the invention, such as in industrial and agricultural equipment, military equipment, trucks and automobiles, locomotives, aircraft and ships or vessels.

Because the individual motor units may be standardized, replacement of the motor units can be easily accomplished by removing an existing motor unit from the motor assembly receiver, and replacing it with a new one. Fluid connections are easily made by mounting the motor unit to the receiver and bolting the motor unit in place, with the fluid ports being automatically aligned. The motor units may be interchangeable, so that differently powered motor units may be received by the same receiver for powering the motor assembly. Thus, a gasoline-powered motor unit, a diesel-powered motor unit, and an electric-powered motor unit may each be placed in the same motor assembly receiver to power the main shaft assembly.

Additionally, multiple motor units may be employed with the same motor assembly. Where multiple motor units are employed, they can each be powered differently. Thus, for example, the motor units may be arranged in banks of motor units, each bank of motor units being powered differently and driving a different shaft element or gear of the main shaft. If a particular fuel or electric power is depleted or can no longer be supplied to a bank of the motor units, the bank of motor units may be disengaged, while power is supplied to the main shaft assembly by the remaining motor units.

The motor assembly can be provided with multiple output shafts, each output shaft being used for a different application, if necessary. Thus, for example, two output shafts may be provided for rotating dual propellers on a ship, boat or airplane. The output shafts, as well as the drive shafts of the individual motor units, can be oriented at almost any angle with respect to the main shaft. This provides a great deal of flexibility to the motor assembly design and configuration, which can be tailored to the particular application of the motor assembly. The use of an output shaft coupled directly to a main power shaft for directly powering auxiliary systems, such as an engine's cooling system, overcomes many of the shortcomings associated with belt driven auxiliary systems commonly found in conventional engines.

The motor assembly allows easy use of both electric motors and combustible fuel engines so that a hybrid engine is produced. This provides a motor assembly that is both fuel efficient as well as providing necessary torque or power in instances where purely electric motors would be insufficient.

The motor units are easily removable and replaced without complicated and lengthy assembly or disassembly, as would be necessary with conventional engines.

The motor assembly has particular application where the availability of a particular fuel supply is uncertain or may be in short supply. In many cases those fossil fuels used for combustion engines are non-interchangeable. Fuels such as diesel, gasoline and natural gas, commonly used to power conventional combustion engines, are typically non-interchangeable with respect to the engines for which they are used. Thus, for example, where both diesel and gasoline powered motor units are employed in the same motor assembly, if either gasoline or diesel fuel is in short supply, one may rely on the motor units that utilize the other available fuel source to power the motor assembly. In this way, the motor assembly has great adaptability in situations where fuel availability may vary.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

I claim:

1. A motor assembly comprising:
a motor assembly housing having at least one motor unit receiver;
a main power shaft assembly housed within the motor assembly housing having a main shaft with a longitudinal axis extending between opposite ends of the main shaft, at least one shaft element coupled to the main shaft, the shaft element being rotatable about the longitudinal axis, the shaft element engaging the main shaft so that rotation of the shaft element about the longitudinal axis causes the main shaft to rotate about the longitudinal axis; and
at least one motor unit that is received by the motor unit receiver of the motor assembly housing, the motor unit having a motor and a drive shaft, the drive shaft being rotatably driven about a drive shaft axis of the drive shaft by the motor, and wherein the motor unit is releasably engagable with the main power shaft assembly when the motor unit is received by the motor unit receiver of the motor assembly housing so that rotation of the drive shaft causes rotation of the shaft element about the longitudinal axis of the main shaft to thereby rotate the main shaft when engaged, the motor unit being substantially self-contained to facilitate removal and replacement of the motor unit.

2. The motor assembly of claim 1, wherein:
there are at least two motor units, each being received by a separate motor unit receiver, each motor unit being capable of rotating the main shaft by rotation of the shaft element by the drive shaft when the other of said at least two motor units is disengaged from the main shaft, and wherein the at least two motor units are capable of rotating the main shaft in a cooperating relationship when both the at least two motor units are engaged with the main shaft.

3. The motor assembly of claim 2, wherein:
there are at least two shaft elements coupled to the drive shaft and spaced apart along the longitudinal axis, and wherein the drive shaft of each of the at least two motor units is engaged with one of the at least two shaft elements.

4. The motor assembly of claim 2, wherein:
the motor of one of the motor units is a combustible fuel engine; and the motor of the other of the at least two motor units is an electric motor.

5. The motor assembly of claim 1, further comprising:
an electric generator engagable with the main shaft and which is driven by rotation of the main shaft when the electric generator is engaged therewith; and
a battery unit electrically coupled to the electric generator for storing electric energy produced by the electric generator.

6. The motor assembly of claim 2, wherein:
the motor of one of the motor units is an electric motor that is operable in a power mode in which the electric motor rotatably drives the drive shaft of said one of the motor units about the drive shaft axis and in a generator mode in which the electric motor serves as an electric generator.

7. The motor assembly of claim 2, wherein:
the motor of each of the at least two motor units is a combustible fuel engine, and wherein each motor of the at least two motor units is powered by a different combustible fuel, the combustible fuel of one of the motors of the at least two motor units being non-interchangeable with the combustible fuel of the other one of the motors.

8. The motor assembly of claim 1, wherein:
the drive shaft axis of the motor unit is at an angle of greater than zero degrees with respect to the longitudinal axis of the main shaft.

9. The motor assembly of claim 1, wherein:
the drive shaft axis of the motor unit is at an angle of less than 90 degrees with respect to the longitudinal axis of the main shaft.

10. The motor assembly of claim 1, wherein:
the main shaft assembly is provided with a clutch mechanism to facilitate engagement and disengagement of the shaft element.

11. The motor assembly of claim 2, wherein:
the drive shafts of each of the motor units are rotated at different rates when cooperating together to rotate the main shaft.

12. The motor assembly of claim 1, further comprising:
at least one output shaft having a longitudinal output shaft axis and which is engaged with the shaft element of the main power shaft so that rotation of the main power shaft causes the output shaft to rotate about the output shaft axis.

13. The motor assembly of claim 12, wherein:
the output shaft axis of the at least one output shaft is at an angle of greater than zero degrees with respect to the longitudinal axis of the main shaft.

14. The motor assembly of claim 12, wherein:
the output shaft axis of the at least one output shaft is at an angle of less than 90 degrees with respect to the longitudinal axis of the main shaft.

15. The motor assembly of claim 1, further comprising:
at least two output shafts, each having a longitudinal output shaft axis, engaged with the shaft element of the main shaft so that rotation of the main power shaft causes each output shaft to rotate about the output shaft axis.

16. The motor assembly of claim 6, wherein:
the motor of the other of the motor units is combustible fuel motor.

17. A motor assembly comprising:
a main power shaft assembly having a main shaft with a longitudinal axis extending between opposite ends of the main shaft, at least one shaft element coupled to the main shaft, the shaft element being rotatable about the longitudinal axis, the shaft element engaging the main shaft so that rotation of the shaft element about the longitudinal axis causes the main shaft to rotate about the longitudinal axis; and
at least two motor units, each motor unit having a motor and a drive shaft, the drive shaft being rotatably driven about a drive shaft axis of the drive shaft by the motor, and wherein each motor unit is releasably engagable with the main shaft so that rotation of the drive shaft of each motor unit causes rotation of the shaft element about the longitudinal axis of the main shaft to thereby rotate the main shaft when engaged, and wherein each motor unit is capable of rotating the main shaft by rotation of the shaft element by the drive shaft when the other of said at least two motor units is disengaged from the main shaft, and wherein the at least two motor units are capable of rotating the main shaft in a cooperating relationship when both the at least two motor units are engaged with the main shaft.

18. The motor assembly of claim 17, wherein:
there are at least two shaft elements coupled to the drive shaft and spaced apart along the longitudinal axis, and wherein the drive shaft of each of the at least two motor units is engaged with one of the at least two shaft elements.

19. The motor assembly of claim 17, wherein:
the motor of one of the motor units is a combustible fuel engine; and the motor of t he other of the at least two motor units is an electric motor.

20. The motor assembly of claim 17, further comprising:
an electric generator engagable with the main shaft and which is driven by rotation of the main shaft when the electric generator is engaged therewith; and
a battery unit electrically coupled to the electric generator for storing electric energy produced by the electric generator.

21. The motor assembly of claim 20, wherein:
the motor of one of the motor units is an electric motor that is operable in a power mode in which the electric motor rotatably drives the drive shaft of said one of the motor units about the drive shaft axis and in a generator mode in which the electric motor serves as the electric generator.

22. The motor assembly of claim 17, wherein:
the motor of each of the at least two motor units is a combustible fuel engine, and wherein each motor of the at least two motor units is powered by a different combustible fuel, the combustible fuel of one of the motors of the at least two motor units being non-interchangeable with the combustible fuel of the other one of the motors.

23. The motor assembly of claim 17, wherein:
the drive shaft axis of the drive shaft of at least one of the motor units is at an angle of greater than zero degrees with respect to the longitudinal axis of the main shaft.

24. The motor assembly of claim 17, wherein:
the drive shaft axis of the drive shaft of at least one of the motor units is at an angle of less than 90 degrees with respect to the longitudinal axis of the main shaft.

25. The motor assembly of claim 17, wherein:
the main shaft assembly is provided with a clutch mechanism to facilitate engagement and disengagement of the shaft element.

26. The motor assembly of claim 17, wherein:
the drive shafts of each of the motor units are rotated at different rates when cooperating together to rotate the main shaft.

27. The motor assembly of claim 17, further comprising:
at least one output shaft having a longitudinal output shaft axis and which is engaged with the shaft element of the main power shaft so that rotation of the main power shaft causes the output shaft to rotate about the output shaft axis.

28. The motor assembly of claim 27, wherein:
the output shaft axis of the at least one output shaft is at an angle of greater than zero degrees with respect to the longitudinal axis of the main shaft.

29. The motor assembly of claim 27, wherein:
the output shaft axis of the at least one output shaft is at an angle of less than 90 degrees with respect to the longitudinal axis of the main shaft.

30. The motor assembly of claim 17, further comprising:
at least two output shafts, each having a longitudinal output shaft axis, engaged with the shaft element of the main shaft so that rotation of the main power shaft causes each output shaft to rotate about the output shaft axis.

31. The motor assembly of claim 17, further comprising:
a motor assembly housing having at least one motor unit receiver; wherein
the main power shaft assembly is housed within the motor assembly housing, and wherein at least one of the motor units is received by the motor unit receiver, with the at least one of the motor units being releasably engagable with the main power shaft assembly when the at least one motor unit is received by the motor unit receiver of the motor assembly housing, the at least one motor unit being substantially self-contained to facilitate removal and replacement of the at least one motor unit.

32. The motor assembly of claim 21, wherein:
the motor of the other of the motor units is combustible fuel motor.

33. A motor assembly comprising:
a motor assembly housing having at least two motor unit receivers;
a main power shaft assembly housed within the motor assembly housing, the main power shaft assembly having a main shaft with a longitudinal axis extending between opposite ends of the main shaft, at least one shaft element coupled to the main shaft, the shaft element being rotatable about the longitudinal axis, the shaft element engaging the main shaft so that rotation of the shaft element about the longitudinal axis causes the main shaft to rotate about the longitudinal axis; and
at least two motor units, each motor unit being independently operated and received by one of the motor unit receivers of the motor assembly housing, each motor unit having a motor and a drive shaft, the drive shaft being rotatably driven about a drive shaft axis of the drive shaft by the motor, and wherein each motor unit is releasably engagable with the main shaft so that rotation of the drive shaft of each motor unit causes rotation of the shaft element about the longitudinal axis of the main shaft to thereby rotate the main shaft when engaged, and wherein each motor unit rotates the main shaft by rotation of the shaft element by the drive shaft when the other of said at least two motor units is disengaged from the main shaft, and wherein the at least two motor units each rotate the main shaft in a cooperating relationship when both the at least two motor units are engaged with the main shaft.

34. The motor assembly of claim 33, wherein:
there are at least two shaft elements coupled to the drive shaft and spaced apart along the longitudinal axis, and wherein the drive shaft of each of the at least two motor units is engaged with one of the at least two shaft elements.

35. The motor assembly of claim 33, wherein:
the motor of one of the motor units is a combustible fuel engine; and the motor of the other of the at least two motor units is an electric motor.

36. The motor assembly of claim 33, further comprising:
an electric generator engagable with the main shaft and which is driven by rotation of the main shaft when the electric generator is engaged therewith; and
a battery unit electrically coupled to the electric generator for storing electric energy produced by the electric generator.

37. The motor assembly of claim 36, wherein:
the motor of one of the motor units is an electric motor that is operable in a power mode in which the electric motor rotatably drives the drive shaft of said one of the motor units about the drive shaft axis and in a generator mode in which the electric motor serves as the electric generator.

38. The motor assembly of claim 33, wherein:
the motor of each of the at least two motor units is a combustible fuel engine, and wherein each motor of the at least two motor units is powered by a different combustible fuel, the combustible fuel of one of the motors of the at least two motor units being non-interchangeable with the combustible fuel of the other one of the motors.

39. The motor assembly of claim 33, wherein:
the drive shaft axis of the drive shaft of at least one of the motor units is at an angle of greater than zero degrees with respect to the longitudinal axis of the main shaft.

40. The motor assembly of claim 33, wherein:
the drive shaft axis of the drive shaft of at least one of the motor units is at an angle of less than 90 degrees with respect to the longitudinal axis of the main shaft.

41. The motor assembly of claim 33, wherein:
the shaft element includes a gear.

42. The motor assembly of claim 33, wherein:
the drive shafts of each of the motor units are rotated at different rates when cooperating together to rotate the main shaft.

43. The motor assembly of claim 33, further comprising:
at least one output shaft having a longitudinal output shaft axis and which is engaged with the shaft element of the main power shaft so that rotation of the main power shaft causes the output shaft to rotate about the output shaft axis.

44. The motor assembly of claim 43, wherein:
the output shaft axis of the at least one output shaft is at an angle of greater than zero degrees with respect to the longitudinal axis of the main shaft.

45. The motor assembly of claim 43, wherein:
the output shaft axis of the at least one output shaft is at an angle of less than 90 degrees with respect to the longitudinal axis of the main shaft.

46. The motor assembly of claim 33, further comprising:
at least two output shafts, each having a longitudinal output shaft axis, engaged with the shaft element of the main shaft so that rotation of the main power shaft causes each output shaft to rotate about the output shaft axis.

47. The motor assembly of claim 37, wherein:
the motor of the other of the motor units is combustible fuel motor.

47. A vehicle or vessel having the motor assembly of claim 1.

46. A vehicle or vessel having the motor assembly of claim 17.

47. A vehicle or vessel having the motor assembly of claim 33.

48. A vehicle or vessel having the motor assembly of claim 16.

49. A vehicle or vessel having the motor assembly of claim 32.

50. A vehicle or vessel having the motor assembly of claim 47.
